(19) United States
(12) Patent Application Publication
(10) Pub. No.: US 2005/0217958 A1
(43) Pub. Date: Oct. 6, 2005

(54) Mechanical coupling

(76) Inventor: David W. Loughnan, Queensland (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 10/520,911

(22) PCT Filed: Jun. 16, 2003
(86) PCT No.: PCT/AU03/00752

§ 371 Date: Jan. 7, 2005

(30) Foreign Application Priority Data
Jul. 9, 2002 (AU) 2002950085

(51) Int. Cl. F16D 13/04

(52) U.S. Cl. 192/42

(57) ABSTRACT

A mechanical coupling for coupling a rotatable driving element to a rotatable driven element to be driven by the driving element, wherein the mechanical coupling comprises a clutch mechanism, mechanically between the driving element and the driven element; and wherein the clutch mechanism is adjustable so that in normal use the driving element can drive the driven element substantially without slippage, but so that a given torque applied to said driven element, other than via the clutch, in order to override the action of the driving element, causes the clutch mechanism to slip, thereby overriding said driving element and allowing the driven element to be driven by the overriding torque, substantially without said overriding torque being applied to the driving element.

### FIELD OF THE INVENTION

The present invention relates to a mechanical coupling and especially, but not exclusively, to a mechanical coupling for coupling a motor to an intermediate portion of a shaft in order to enable the motor to drive the shaft, while allowing the motor to be rotationally decoupled from the shaft by application of a predetermined override torque to the shaft. The invention is particularly, although not exclusively, directed to coupling a motor for automatically steering a vehicle to a steering shaft of the vehicle while allowing decoupling of the motor and the shaft by application of a torque to the shaft by an operator operating a steering wheel attached to the shaft. A method for mechanical coupling of a driving element and a driven element is also provided.

### BACKGROUND OF THE INVENTION

Automatic steering systems in which the steering of a vehicle is operated by a computer controlled motor are well known in agricultural vehicles, such as tractors, and are likely to become common in passenger vehicles as the technology develops. An important safety consideration of such systems is that an operator should be able to quickly and easily manually override the automatic steering system. Typically, a separate control is provided, such as a switch, which can be used by an operator to override the automatic steering system. However, it is desirable to allow an operator to override the automatic steering system merely by operation of the normal steering controls of the vehicle. Several systems have been proposed, including systems which electronically detect torque applied to the steering wheel and actively operate a control system to decouple the motor from the steering system. However, there appears to be a need for an improved, or at least alternative mechanical coupling to provide an override system. It is preferable that at least some variations of such a system should be safe and simple to operate and be suitable for use with vehicles in which a steering wheel operates ground engaging wheels via a steering shaft and a power steering system.

### SUMMARY OF THE INVENTION

According to a first aspect of the present invention, there is provided a mechanical coupling for coupling a rotatable driving element to a rotatable driven element to be driven by the driving element, wherein the mechanical coupling comprises:

a clutch mechanism, mechanically between the driving element and the driven element; and

wherein the clutch mechanism is adjustable so that in normal use the driving element can drive the driven element substantially without slippage, but so that a given torque applied to said driven element, other than via the clutch, in order to override the action of the driving element, causes the clutch mechanism to slip, thereby overriding said driving element and allowing the driven element to be driven by the overriding torque, substantially without said overriding torque being applied to the driving element.

Preferably, in use, the clutch is adjustable so that the overriding torque is of a magnitude that can be manually applied to the driven member.

A preferred embodiment therefore provides a mechanical coupling which allows convenient manual overriding of an automatically controlled driven element, without the need to apply the overriding torque to the driving element or (via the driving element) to a system controlling the driving element. In a preferred embodiment, in use, the clutch is set to slip upon application of a torque greater than a given predetermined torque and, preferably, the magnitude of the predetermined torque is less than about 20 Nm. In preferred embodiments the magnitude of the predetermined torque is of the order of 0.4 Nm, and most preferably the magnitude of the predetermined torque is between 0.1 Nm and 2 Nm.

Preferably, in use, the clutch is adjusted so that the clutch mechanism can slip to prevent transmission of torque greater than a given predetermined torque, from the driving element to the driven element.

In preferred embodiments the mechanical coupling thus helps avoid undesirable torque peaks being applied to the driven element by the driving element.

Preferably, the driven element is a shaft.

Preferably, the shaft is elongate, being greater in axial length than in radial width.

Preferably, the driven element is a steering shaft of a vehicle.

The driven element may be a member for rotational connection to, and driving of, a shaft.

The driven element may, for example, be an auxiliary shaft for coupling to a shaft, or a sprocket, gear wheel or the like for driving a shaft.

Preferably, the mechanical coupling includes a secondary driving element which, in use, is provided mechanically between the driving element and the clutch mechanism.

Preferably, in use, the secondary driving element is rotatable substantially coaxially with the driven element.

Preferably, there is provided a link for connecting the driving element to the secondary driving element.

Preferably, the driving element is connected to the secondary driven element via a gear mechanism.

Preferably, the link includes, constitutes or forms part of the gear mechanism.

Provision of the clutch between the gear mechanism (or link) and the driven element means that when the clutch slips because of application of an overriding torque applied to the driven element, the driven element need not move the gear mechanism, which would typically be adversely geared and/or provide high resistance because of frictional forces. The gear mechanism may be a worm gear. The link is of particular importance if the driving element does not rotate coaxially with the driven element.

Preferably, the clutch mechanism includes a first clutch element which, in use, is rotationally coupled to, and driven by, the driving element, and a second clutch element which, in use, is rotationally coupled to the driven element, and the clutch mechanism is adapted to allow relative rotation of the first and second clutch elements when the overriding torque is applied to the second clutch element.

Preferably, the clutch mechanism is configured to fit around a shaft.

In preferred embodiments the first and second clutch elements have central axial voids through which a shaft may extend. In preferred embodiments the shaft around which the clutch is configured is the driven element, which in some embodiments is the steering shaft of a vehicle, allowing the clutch to be compactly coaxially mounted around the shaft. Alternatively, or additionally, the shaft around which the clutch is configured may serve to align and stabilise components of the mechanical coupling relative to each other.

preferably, the clutch mechanism includes a clutch plate with a central void for passage of the shaft.

Preferably, adjustment of the clutch is regulated by an electronic control system.

Preferably, the mechanical coupling is provided with a fluid controlled system for adjustment of the clutch.

The fluid is preferably compressed air or a hydraulic fluid.

Preferably, the fluid controlled system includes a fluid chamber.

Preferably, the fluid chamber is configured to fit around a shaft.

In preferred embodiments, in use, the shaft around which the fluid chamber fits is the driven element, which in some embodiments is the steering shaft of a vehicle. Alternatively, or additionally the shaft around which the clutch is configured to fit may serve to align and stabilise components of the mechanical coupling relative to each other. The mechanical coupling may include the shaft, as a part thereof, or may be provided for fitting about a shaft.

Preferably, a piston is provided in the fluid chamber and varying the fluid pressure varies a force applied via the piston to rotationally couple first and second clutch elements of the clutch mechanism.

Preferably, the fluid controlled system adjusts the clutch by regulating the fluid pressure which acts upon the piston.

Preferably, the secondary driving element is configured to fit around a shaft.

In preferred embodiments the shaft around which the secondary driving element is configured to fit is the driven element, which in some embodiments is the steering shaft of a vehicle. Alternatively, or additionally the shaft around which the secondary driving element is configured to fit may serve to align and stabilise components of the mechanical coupling relative to each other.

Preferably, the clutch mechanism has a clutch housing and at least part of the housing drives, or forms at least part of, one of the clutch elements.

Preferably, there is provided a connection element which extends through a passageway defined by the fluid chamber, and into the clutch mechanism, and part of the connection member is driven by or forms at least part of one of the clutch elements.

Preferably, the connection element is configured to fit around a shaft.

In preferred embodiments the shaft around which the connection element is configured to fit is the driven element, which in some embodiments is the steering shaft of a vehicle. Alternatively, or additionally, the shaft around which the connection element is configured to fit may serve to align and stabilise components of the mechanical coupling relative to each other.

Preferably, the connection element includes a shaft portion.

The shaft portion preferably extends through a passageway defined by the fluid chamber.

Preferably, application of fluid pressure to the piston forces the piston away from one end of the fluid chamber, and the increased displacement between the piston and the said one end of the fluid chamber forces the clutch elements into, or towards, an engaged configuration.

An important feature of some preferred embodiments is that the coupling defaults to a setting in which the clutch is not engaged, that is, it defaults to a position in which (manual) override is facilitated. In the case of a fluid operated system, it is preferred that loss of fluid pressure results in disengagement of the clutch mechanism.

Preferably, the torque applied to the driven element other than via the clutch mechanism is applied manually via a steering wheel or other steering element.

The fluid controlled system may be operable from a pump used for the power steering system of the vehicle.

According to a second aspect of the present invention, there is provided a system for coupling an automatic steering control system to a steering system of a vehicle, while allowing manual override of the automatic steering control system by a user operating the normal steering control of the vehicle, said system including a mechanical coupling in accordance with the first aspect of the present invention. The system may further include preferred and/or optional features of the first aspect.

Preferably, the clutch is adjusted by a computerised controller.

Preferably, the computerised controller which adjusts the clutch also operates the automatic steering control system. A system including the mechanical coupling of the first aspect, in which the driving element is driven by a control system other than an automatic steering system and in which the driven element is connected to a system other than a steering system of a vehicle, is also provided.

According to a third aspect of the present invention, there is provided a method of coupling a rotatable driving element to a rotatable driven element, to be driven by the driving element, comprising the steps of:

providing a clutch mechanism, mechanically between the driving element and the driven element, so that the driven element may be driven by the driving element via the clutch mechanism; and

adjusting the clutch mechanism so that, in normal use, the driving element can drive the driven element substantially without slippage, but so that a given torque applied to said driven element other than via the clutch mechanism, in order to override the action of the driving element, causes the clutch mechanism to slip, thereby overriding said driving element and allowing the driven element to be driven by the overriding torque, without said overriding torque being applied to the driving element.

Preferably, the step of adjusting the clutch mechanism includes adjusting the clutch mechanism so that the torque transmissible by the clutch mechanism without slippage is greater than the torque required to allow the driving element to drive the driven element in normal use, but less than the given overriding torque.

Thus in preferred embodiments, overriding of the driving element occurs automatically upon application of a suitable override torque, and does not require detection of the override torque and separate active operation of a mechanism to rotationally decouple the driving element from the driven element.

In preferred embodiments, the driving element may drive the driven element, via the clutch, in either rotational direction, and application of an overriding torque to the driven element in either direction will cause the clutch to slip.

Preferably, the step of adjusting the clutch mechanism includes adjusting the clutch mechanism during rotation of the driving element.

Preferably, the step of adjusting the clutch mechanism includes adjustment so that the overriding torque is of a magnitude that can be manually applied to the driven member.

A preferred embodiment therefore provides a method which allows convenient manual overriding of an automatically controlled driven element, without the need to apply the overriding torque to the driving element or (via the driving element) to a system controlling the driving element. In a preferred embodiment, in use, the clutch is set to slip upon application of a torque greater than a given predetermined torque and, preferably, the magnitude of the predetermined torque is less than about 20 Nm. In preferred embodiments the magnitude of the predetermined torque is of the order of 0.4 Nm, and most preferably the magnitude of the predetermined torque is between 0.1 Nm and 2 Mm.

Preferably, the driving element is an output of an automatic steering system for a vehicle, and the driven element controls the steering of the vehicle.

Preferably, the driven element is one of a steering shaft of the vehicle and an auxiliary element connected to the steering shaft of the vehicle.

Preferably, the torque applied to the driven element other than via the clutch mechanism is applied manually via a manually operated steering controller.

The steering controller is typically a steering wheel, but could be an alternative steering controller.

Preferably, the method includes the step of detecting relative rotation of the driving element and the driven element which corresponds to the driving element being overridden, and least partially releasing the clutch mechanism in response to the detection of the relative rotation.

This removes or reduces the rotational coupling between driving and driven elements when an overriding torque is applied, and further facilitates overriding of the driven element. The release of the clutch mechanism preferably lasts only until one or more predetermined parameters are met, such as, for example a predetermined time elapsed and/or a predetermined relative rotation of the driven and driving elements (such as a period with little or no relative rotation).

Preferably, the method includes use of a mechanical coupling in accordance with the first aspect of the present invention and/or in accordance with the second aspect of the present invention.

### BRIEF DESCRIPTION OF THE DRAWINGS

Embodiments of the present invention will now be described by way of example only with reference to the accompanying drawings in which:

FIG. 1 is an axial cross-section along a portion of a shaft, showing schematically the configuration of a preferred embodiment of a mechanical coupling in accordance with the present invention, in a state corresponding to an automatically driven motor being coupled to the shaft;

FIG. 2 is a schematic cross-sectional representation of the embodiment of FIG. 1 in a state where the automatically driven motor is not mechanically coupled to the shaft so as to drive the shaft;

FIG. 3 shows schematically the provision of the embodiment of FIGS. 1 and 2 in a steering system of a vehicle, where the shaft is the steering shaft of the vehicle;

FIG. 4 shows schematically the provision of the embodiment similar to that of FIGS. 1 and 2 in the steering system of a vehicle where the mechanical coupling is configured around a shaft which is an auxiliary shaft coupled to a steering shaft of a vehicle;

FIG. 5 is a cross-sectional representation of a mechanical coupling similar to the embodiment of FIGS. 1 and 2, but more accurately to scale;

FIG. 6 is a schematic cross-sectional representation of an alternative embodiment of a mechanical coupling in accordance with the present invention;

FIG. 7 shows schematically provision of an alternative embodiment of mechanical coupling in accordance with the present invention, in a steering system of a vehicle;

FIG. 8 is a schematic cross-sectional representation of an alternative embodiment of mechanical coupling; and

FIG. 9 is a schematic cross-sectional representation of another alternative embodiment of mechanical coupling.

### DETAILED DESCRIPTION OF THE DRAWINGS

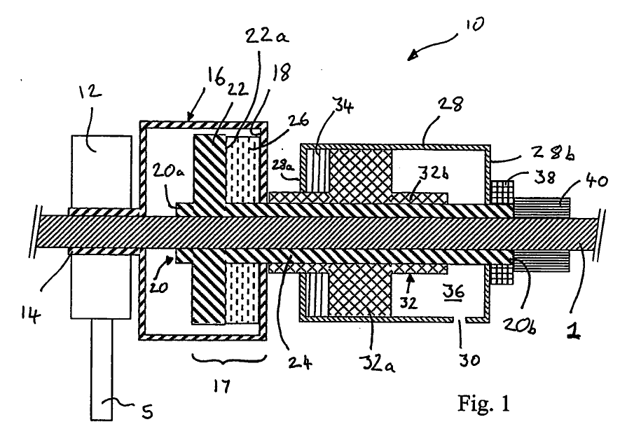

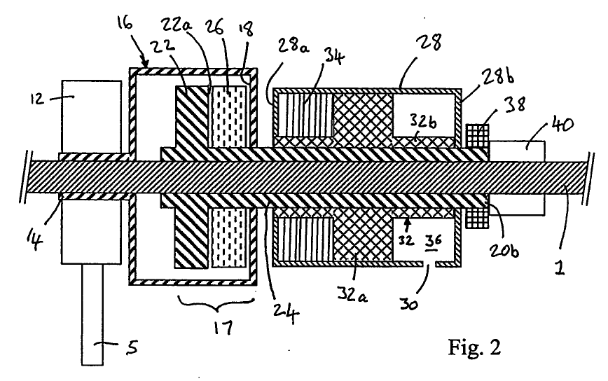

With reference to FIGS. 1 and 2, a preferred embodiment of a mechanical coupling in accordance with the present invention will now be described.

A mechanical coupling generally designated 10 provides a coupling between a rotatable driven element in the form of a shaft 1, which may be in the form of a steering shaft, and a rotatable driving element in the form of an output shaft 5 from an automatically driven motor (not shown in FIGS. 1 and 2) of an automated steering control system. The output shaft 5 of the automatically driven motor is connected to a link in the form of a worm gear mechanism 12 in order to convert the rotary motion of the output shaft 5, which is not coaxial with the shaft 1, into rotary motion of a secondary driving element in the form of a generally cylindrical sleeve 14 which is coaxial with the shaft 1. The worm gear 12 may also be geared to provide a desired gear ratio between the input shaft 5 and the sleeve 14. The generally cylindrical sleeve 14 extends around (or is configured around), but is not directly rotationally coupled to, the shaft 1. The generally cylindrical sleeve 14 is rigidly coupled to a first end of clutch housing 16 which is generally cylindrical and which rotates with the generally cylindrical sleeve 14. The clutch housing 16 extends around (or is configured around), but is not directly rotationally coupled to, the shaft 1. The clutch housing 16 includes a drive face 18 on an inner surface thereof which is at a second end of the clutch housing, and which extends generally radially with respect to the shaft 1. Located partially within the clutch housing 16, there is provided a connection element in the form of a connection member 20 which includes a flange portion 22 and a generally cylindrical shaft portion 24. The connection member 20 defines an axial bore, through which the shaft 1 passes. The flange portion 22 of the connection member 20 extends, from a first end 20a of the connection member 20, generally radially away from the axial bore, and the shaft 1. The flange portion 22 is entirely contained inside the clutch housing 16 and includes a contact face 22a which generally faces the drive face 18. The generally cylindrical shaft portion 24 of the connection member 20 extends along the shaft 1, away from the worm gear 12, and extends for some distance before terminating at a second end 20b of the connection member 20.

The clutch housing 16 further contains a generally annular clutch plate 26 which lies between the drive face 18 of the clutch housing 16 and the contact face 22a of the flange portion 22 of the connection member 20. As can be seen in FIG. 1, when the clutch plate 26 is in firm contact with both the drive face 18 and the contact face 22a, these elements together constitute a clutch mechanism, generally designated 17, in an engaged state.

The-clutch mechanism 17 is operable by an operating cylinder 28 which is operated by fluid pressure resulting from regulated input of a fluid (typically hydraulic fluid for a hydraulic system or compressed air for a pneumatic system) through a fluid inlet 30 provided in a wall of the operating cylinder 28. Provided in the operating cylinder is an operating piston 32. The operating piston 32 is provided with a through bore which coaxially accommodates the shaft 1 and a part of the includes a flange portion 32a which extends radially away from the shaft 1 and the outer periphery of which seals against the casing of the operating cylinder 28. The shaft 1 and the generally cylindrical shaft portion 24 of the connection member 20 pass axially through the centre of the flange portion 32a. The operating piston 32 further includes a generally cylindrical portion 32b, which extends axially on either side of the flange portion 32a. The cylindrical portion 32b of the operating piston 32 includes a cylindrical bore therethrough, through which the steering shaft 1 and the generally cylindrical shaft portion 24 of the connection member 20 extend. The cylindrical portion 32b of the operating piston 32 is sealed against the generally cylindrical shaft portion 24 of the connection member 20 by seals (not shown).

The operating cylinder 28, may contain a bias member, preferably in the form of a helical spring 34 which provides a bias force to bias the operating piston 32 away from the clutch housing 16. The helical spring 34 is provided between the flange portion 32a of the operating piston 32 and a first end 28a of the operating cylinder 28. The first end 28a of the operating cylinder 28 corresponds to the end of the operating cylinder 28 which is closer to the clutch housing 16 and worm gear 12. Between the flange portion 32a of the operating piston 32 and a second end 28b of the operating cylinder, is provided a fluid chamber 36 into which fluid from the fluid inlet 30 may be forced.

Increase in fluid pressure in the fluid chamber 36 forces the operating piston against the bias force of the helical spring 34 and towards the first end 28a of the operating cylinder 28.

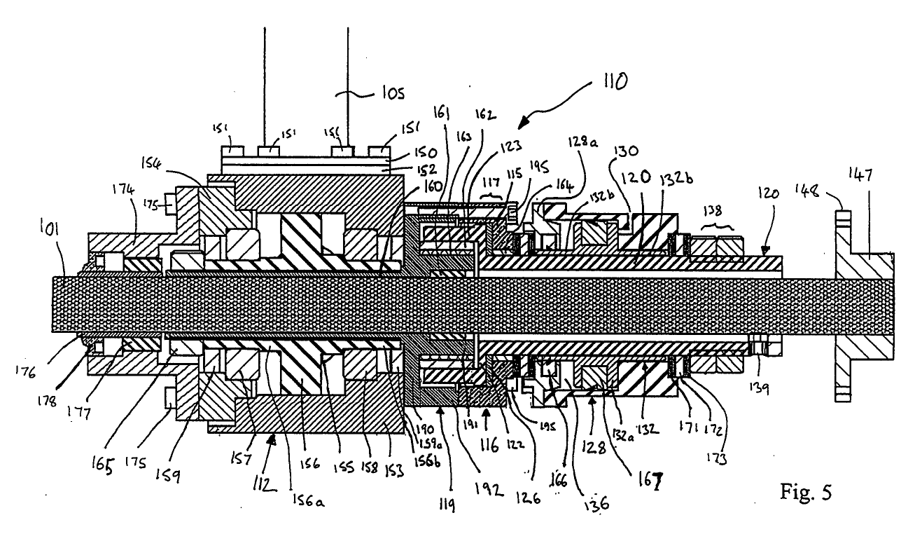

Attached to the second end 20b of the connection member 20, there is provided a connection arrangement in the form of a pair of castellated nuts 38 which, when the fluid pressure in the fluid chamber 36 is relatively high (as shown in FIG. 1), may be borne upon by the outside of the second end 28b of the operating cylinder 28. A thrust washer (not shown) is preferably provided between the castellated nuts 38 and the second end 28b of the operating cylinder 28. The castellated nuts 38 extend around the circular circumference of the second end 20b of the connection member 20, so that both the second end 20b of the connection member 20 and also part of the shaft 1 pass through the castellated nuts 38. Rotationally coupled to the second end 20b of the connection member 20, there is provided one unit 40 of a two-unit flexible drive mechanism. The other unit (not shown) of the flexible drive mechanism is rigidly attached to the shaft 1. It should be noted that in the embodiment of FIGS. 1 and 2, the flexible drive is the only point at which the mechanical coupling 10 is directly rotationally coupled to the shaft 1. It will be appreciated by those skilled in the art that in order to support the mechanical coupling 10 on the shaft 1 and also in order to support, for example, the clutch housing 16 on the connection member 20, and the operating piston 32 on the generally cylindrical shaft portion 24 of the connection member 20 and (whilst maintaining the integrity of the chamber 36) various bearings or seals may be required. For simplicity, these are not shown in FIGS. 1 and 2 (although such elements are illustrated in FIG. 5) and provision of such elements could be accomplished by the person skilled in the art.

FIG. 1 represents a first state of the mechanical coupling 10, in which the clutch mechanism 17 (formed by a first clutch element in the form of the contact face 22a of the flange portion 22, the clutch plate 26 and a second clutch element in the form of the drive face 18 of the second end wall of the clutch housing 16) is engaged. It should be appreciated that any appropriate form of clutch mechanism could be used and a fluid filled clutch mechanism may be desirable in order to reduce wear on the elements thereof. The engagement of the clutch mechanism is controlled by the application of fluid pressure in the chamber 36.

When there is low fluid pressure in the chamber 36 (or in this embodiment insufficient fluid pressure to overcome the bias force provided on the operating piston 32 by the helical spring 34) the mechanical coupling will be in the second state, illustrated in FIG. 2, that is, the operating piston 32 will not extend far out of the first end 28a of the operating cylinder 28. Consequently, the castellated nuts 38 and the clutch housing 16 will not be forced away from each other, so that the drive face 18 of the clutch housing 16 and the clutch plate 26 will not be forced against the contact face 22a of the flange portion 22. In this second state, as illustrated in FIG. 2, when the generally cylindrical sleeve 14 which forms the output from the worm gear 12 rotates, also causing the clutch housing 16 to rotate, this rotation will not be transmitted via the clutch mechanism 17 to the connection member 20 and thus will not be transmitted to the shaft 1.

When adequate fluid pressure is applied in the chamber 36, the operating piston 32 is forced towards the first end 28a of the operating cylinder 28, against the bias force of the helical spring 34. As illustrated in FIG. 1, the cylindrical portion 32b of the operating piston 32 therefore extends a significant distance past the first end 28a of the operating cylinder 28 so that an end portion thereof abuts and is forced against the clutch housing 16 forcing the drive face 18 and the clutch plate 26 against the contact face 22a of the flange portion 22 of the connection member 20 (that is, the drive face 18 and clutch plate 26 are forced to the left, as seen in FIG. 1, relative to the contact face 22a). The flange portion 22 is not free to move away from the clutch plate 26 (to the left as shown in FIG. 1) because the second end 28b of the operating cylinder 28 abuts the castellated nuts 38 applying a force directed away from the worm gear 12 (that is, to the right as shown in FIG. 1) which also provides a force on the flange portion 22 away from the worm gear 12 and towards the clutch plate 26. Thus, when there is sufficient fluid pressure in the fluid chamber 36, the clutch mechanism is engaged and the rotation of the worm gear 12 and the clutch housing 16 is transmitted through the clutch plate 26 to the flange portion 22 and through the connection member 20 and flexible drive unit 40 to the shaft 1.

Thus, the fluid pressure dictates whether the clutch is engaged or not and consequently whether the worm gear, and attached automatic steering system, is mechanically coupled to the shaft 1. (In this context, the term “mechanically coupled” is used to mean coupled together so as to be able to transmit rotation, such as is the case when elements are connected in a drive train and the phrase “mechanically between” is used to indicate that an element is between two other elements in a drive train, rather than (necessarily) being located physically between the two other elements.)

It should be appreciated that the distances moved by the various parts are exaggerated in FIGS. 1 and 2 in order to clearly illustrate operation of the coupling. In a preferred embodiment, movement of the contact face 22 of only a fraction of a millimeter may be sufficient to adequately engage or disengage the clutch mechanism.

The amount of fluid pressure applied to the chamber 36 is of critical importance to the functioning of the mechanical coupling 10. In the preferred embodiment, it is intended that an operator of the vehicle, such as a small tractor, into which the automatic steering system and mechanical coupling 10 have been installed, should be able to quickly, easily and intuitively override the automatic steering system merely by turning the steering wheel of the vehicle. This is achieved by setting the pressure of fluid in the operating cylinder 28 to a level at which the normal operating torque applied by the automatic steering system via the worm gear 12 will not cause the clutch mechanism to slip, but the torque applied by a person operating the vehicle, by turning the steering wheel of the vehicle, will be sufficient to cause the clutch to slip. Crucially, because the vehicle has a power steering system, the torque applied by the automatic motor to the steering shaft, via the worm gear 12 and clutch, need be only small. For example, torque of about 3 in lbs, about 0.3 Nm, may be adequate to drive a steering shaft of a small tractor which, in a preferred embodiment, corresponds to the shaft 1. Clearly, with the clutch mechanism set so that there is no clutch slippage at 0.3 Nm, but so that slippage will occur at, for example, an applied torque of between 0.6 and 1.0 Nm, the connection of the worm gear 12 to the shaft 1 can be easily intuitively and immediately overcome by an operator turning the steering wheel of the vehicle. A strong driver might be able to impart a torque of well over 100 Nm to a steering shaft, via a large steering wheel, so it will be appreciated that requiring a given torque of about 1 Nm to cause the clutch to slip will mean that applying enough torque to override the automatic steering system will have little or no effect on the amount of effort required to manually steer the vehicle. Furthermore, adjusting the clutch mechanism to allow slippage at a torque which is only slightly greater than the torque applied by the automatic control system in normal use, allows the clutch to slip, even without manual override, if the automatic control system attempts to apply an abnormally high torque to the shaft, or if the shaft is forced (e.g. by impact of the wheels with an obstacle) in a way which could otherwise transmit an undesirably large torque into the automatic control system. With the fluid pressure correctly maintained to give the desired slip characteristics for the clutch mechanism 17, it can be seen that the described embodiment provides a mechanical coupling for an automatic steering system (or other control system) to operate a driven shaft, such as shaft 1, whilst allowing quick, simple and intuitive override by an operator. Operation of the illustrated arrangement is not dependent upon the direction of rotation and thus operates effectively in a system such as a steering system for a vehicle, in which both automatic operation and manual override must be operable in both rotational directions. It will be appreciated that when an operator ceases to operate the shaft, the torque will drop below the torque required to make the clutch slip, and automatic control of the shaft is therefore automatically resumed.

The fluid pressure in the fluid chamber 36 required to maintain such a light setting of the clutch mechanism 17, is relatively small. In one embodiment, the clutch mechanism is operated hydraulically and needs only approximately 20 lbs per square inch or about 140 kPa fluid pressure. Again, in the preferred embodiment, the worm gear 12 gives a gearing of 10 to 1, and as previously discussed the torque required to turn the shaft 1 is low, so a hydraulic motor can effectively operate the steering system using a fluid pressure of approximately 200 lbs per square inch (i.e. about 1,400 kPa). A typical power steering system for a tractor might use fifteen times this fluid pressure and it is thus possible to use the hydraulic pump of the power steering system of the vehicle to drive the motor which moves the shaft 1 and to provide the fluid pressure required to keep the clutch mechanism 17 lightly engaged. This may use sufficiently little of the power steering system's capacity to have a negligible or tolerably small effect on the power steering system. In such an embodiment, it is preferred that a pressure reducing valve be used for operation of the hydraulic motor of the automatic steering system to moderate the amount of hydraulic fluid required, and providing pressure reduction in this way also prevents the hydraulic motor from acting too aggressively upon the shaft 1.

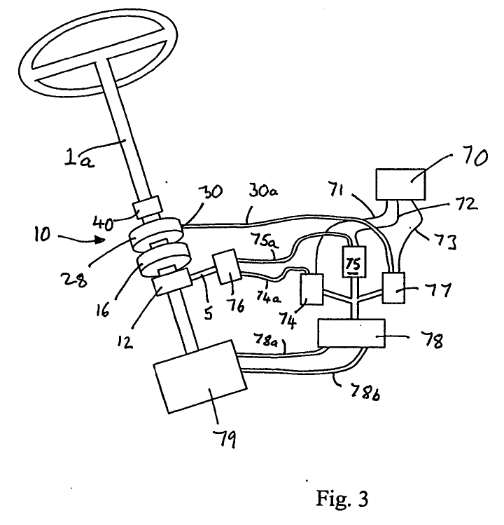

In FIG. 3, a system including a mechanical coupling of the type shown in FIGS. 1 and 2 is schematically depicted and reference numerals corresponding to those used in FIGS. 1 and 2 are used in FIG. 3 to designate corresponding features. In FIG. 3, the mechanical coupling is attached to, and configured around, a shaft 1 in the form of a steering shaft, designated la in FIG. 3. An electronic control system based around a computer 70 is used for automatic steering of a vehicle, and in a preferred embodiment a system based on differential GPS (global positioning system) is used. Use of systems based on differential GPS to automatically steer vehicles is known per se and will not be described herein in detail. The system, including the computer 70 which provides the automatic steering input, preferably provides at least first, second and third computer outputs 71, 72, 73, respectively. The first and second computer outputs 71, 72 control first and second pumps 74, 75 which are connected by hydraulic hoses 74a, 75a to a hydraulic motor 76. The first and second pumps 74, 75 correspond to first and second directions of operation for the hydraulic motor 76 to operate the motor output shaft 5 which drives the worm gear 12. The third computer output 73 controls a solenoid pump 77 for pumping hydraulic fluid through a hydraulic hose 30a into the cylinder inlet 30 of the operating cylinder 28 to maintain the clutch in its lightly weighted condition. The hydraulic fluid is supplied to the first and second pumps 74, 75 and to the solenoid pump 77 at ample pressure by a powerful hydraulic pump 78 which supplies a power steering system 79 of the vehicle via hydraulic hoses 78a, 78b. Thus the computer 70, in addition to controlling the steering of the vehicle, controls the fluid pressure which operates the clutch mechanism, thereby ensuring that the automatic control system can control the steering of the vehicle, but that easy and convenient manual override is always available.

of course, safety is a major consideration and it will be appreciated that the described embodiment will default to a position in which the clutch is not engaged if there is a lack of fluid in the chamber 36 (for example, due to failure of a hose or pump).

The chamber 36 or system suppling hydraulic fluid to the chamber 36 may include an additional pressure sensitive safety system (such as a bypass valve) in order to prevent the fluid pressure in the chamber 36 from increasing to a level where the clutch would not slip if manual override of the shaft 1, 1a were attempted. As an alternative or additional emergency system, the flexible drive may include a friction clutch, adjusted to allow slippage between the connection member 20 and the shaft 1, 1a at a manually attainable torque, but a torque which is distinctly higher than that required to cause slippage of the clutch mechanism 17 during effective operation. In one embodiment, a torque of about 5 Nm is suitable, allowing safe operation of the driven element without requiring manual operation of the driving element (and being sufficiently higher than a 0.6-1 Nm torque setting for the fluid operated clutch mechanism), but providing enough resistance to a user to indicate a problem. In preferred embodiments such a friction clutch is for emergency use only since the characteristics of most such friction clutches make them unsuitable for regular use as the normal override mechanism.

In the embodiment of FIGS. 1 and 2, it can be seen that when the clutch is disengaged (and therefore, also, when manual override of the shaft 1 is achieved by slippage of the clutch) the only elements of the mechanical coupling 10 which must be rotated by the operator along with the steering shaft 1 are the flexible coupling 40, the castellated nuts 38 and the connection member 20. Clearly, this provides a considerable benefit in ease of handling the steering system over, for example, providing the clutch mechanism between the worm gear 12 and the motor 76, since the relatively cumbersome (and possibly adversely geared) worm gear 12 need not be manually rotated by the operator along with the steering shaft 1.

It will also be noted that the described embodiment of FIGS. 1 and 2 may be provided in a vehicle in an arrangement which is compact and co-axial with the steering shaft, and will thus not require significant additional space. Furthermore, the embodiment of FIGS. 1 and 2 may be connected to the steering shaft without substantially disturbing the normal geometry of the steering system of the vehicle. Complex fitting to the steering shaft is not required since the mechanical coupling is simply slid over the shaft 1 and connected thereto at the flexible drive. The embodiment of FIG. 3 is particularly convenient where the vehicle provides ample space around the steering shaft, but relatively little space in the vicinity of the power steering system 79.

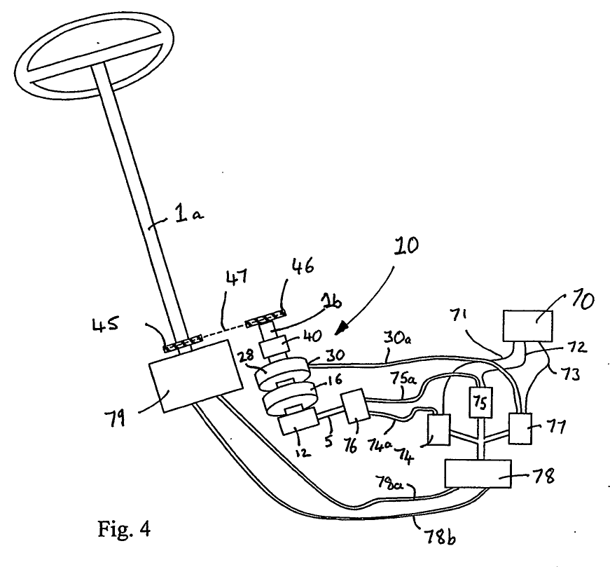

FIG. 4 illustrates an alternative system to the system illustrated in FIG. 3, but one which has many similarities, and corresponding elements are designated by corresponding reference numerals. The main difference between the embodiment of FIG. 4 and the embodiment of FIG. 3 is that whereas in the embodiment of FIG. 3 the mechanical coupling 10 is configured around the steering shaft 1a, in the embodiment of FIG. 4, the mechanical coupling 10 is configured around an auxiliary shaft 1b. In the embodiment of FIG. 4, the auxiliary shaft 1b is coupled to the steering shaft 1a by a first sprocket 45 provided on the steering shaft 1a and a second sprocket 46 provided on the auxiliary shaft 1b. The first and second sprockets are coupled by a chain 47 so that the automatic steering system can operate the steering shaft 1a by effecting rotation of the auxiliary shaft 1b.

This embodiment is particularly convenient where the vehicle layout provides ample space in the region of the power steering system 79 but limited space in the vicinity of the steering shaft 1a. Although a sprocket and chain connection between the auxiliary shaft and the steering shaft is illustrated in FIG. 4 and described above, it will be appreciated that other forms of connection between the shafts 1a, 1b could be used (for example a belt drive, or direct connection of gears or cogs). In the illustrated embodiment, the clutch mechanism (designated 17 in FIGS. 1 and 2, but not shown in FIG. 4) is controlled by the computer 70 to allow the automatic steering system, via the worm gear 12 to drive the auxiliary shaft 1b, and hence the steering shaft 1a in normal use, but to allow an operator applying a torque manually to the steering wheel to cause the clutch to slip so that the automatic steering system can be overridden.

FIG. 5 is a cross-sectional view, generally corresponding in many respects to the embodiment of FIGS. 1 and 2, but less schematic, being substantially to scale, and including various fixing and housing elements, bearings and bushes not shown in FIGS. 1 and 2.

As shown in FIG. 5, an auxiliary shaft 101 has first and second ends (respective to the left and right of FIG. 5) and is provided with a sprocket plate 147 at the second end thereof and a mechanical coupling 110 provided around a greater portion of the shaft 101. (Although an auxiliary shaft 101 is shown, it will be appreciated that the shaft portion about which the mechanical coupling 110 is formed could alternatively be a portion of a steering shaft.) The sprocket plate 147 is provided with a number of teeth 148. The mechanical coupling 110 includes a clutch housing 116 (provided generally centrally of the shaft 101) which corresponds generally to the clutch housing 16 of FIGS. 1 and 2. The mechanical coupling further includes an operating cylinder 128, provided around the shaft between the clutch housing 116 and the sprocket plate 147, the operating cylinder 128 corresponding generally to the operating cylinder 28 of FIGS. 1 and 2.

Towards the first end of the shaft 101 is a worm gear mechanism 112, corresponding generally to the worm gear 12 of FIGS. 1 and 2, which is operated by a driving element in the form of an input shaft 105 driven, in this application, by an automatic steering control system (not shown).

The input shaft 105 is connected to the worm gear mechanism 112 by a mounting collar 150, secured by a number of fasteners such as bolts 151. A seal 152 is provided between the mounting collar and the worm gear mechanism 112.

The worm gear mechanism 112 has a housing which includes a main housing element 153, to which the mounting collar 150 is fixed and a first end housing element 154 which is towards the first end of the shaft 101. Inside the housing of the worm gear mechanism 112 is provided a worm shaft 155, driven by the input shaft 105, and a gear wheel 156 which is driven by the worm shaft 155. The gear wheel 156 is coaxial with and extends around the shaft 101 (but is not directly rotationally coupled thereto).

To assist alignment of the gear wheel 156, first and second generally cylindrical gear wheel portions 156a, 156b which are coaxial with the shaft 101 extend to either axial side of the gear wheel. The first generally cylindrical gear wheel portion 156a is supported against the first end housing element 154 by a first end bearing 157. The second generally cylindrical gear wheel portion 156b is supported against the main housing element 153 by a second end bearing 158.

A first end seal 159 is provided between a portion of the first generally cylindrical gear wheel portion 156a which extends through the first end bearing 157, and the first end housing element 154. A second end seal 159a is provided between a portion of the second generally cylindrical gear wheel portion 156b which extends through the second end bearing 158, and the main housing element 153. Although generally cylindrical, the first and second generally cylindrical gear wheel portions 156a, 156b may include steps or other features to assist in location of the end bearings 157, 158 and/or first end seal 59.

Between the gear wheel 156 and the shaft 101 is provided a secondary driving element in the form of a generally cylindrical sleeve 160, which is rotationally coupled to the gear wheel 156. The shaft 101 extends through the generally cylindrical sleeve 160, but is not directly rotationally coupled thereto. The generally cylindrical sleeve 160 corresponds generally to the sleeve 14 of FIG. 1. A first end of the generally cylindrical sleeve 160 (to the left as shown in FIG. 5) bears a retaining nut 165 for retaining the gear wheel relative to the generally cylindrical sleeve 160. A second end of the generally cylindrical sleeve 160 extends to the end of the worm gear mechanism which is closer to the clutch housing 116. In this embodiment, the worm gear mechanism 112 may be regarded as a geared link between the input shaft 105 and the generally cylindrical sleeve 160.

The generally cylindrical sleeve 160 is formed as part of a first clutch housing member 119 which forms part of the clutch housing 116. Extending radially from the generally cylindrical sleeve 160, at the second end thereof, is a flange portion 190 of the first clutch housing member 119. The flange portion 190 may be regarded as forming a first end wall of the clutch housing 116 and a second end wall of the housing of the worm gear mechanism 112.

Extending axially from the flange portion 190 are radially spaced apart inner and outer cylindrical portions 191, 192 respectively, of the first clutch housing member 119. The inner cylindrical portion 191 is coaxial with the shaft 101 and serves to support the clutch housing 116 relative to the shaft 101 by means of a bearing 161 provided between the shaft 101 and an inner surface of the inner cylindrical portion 191. The outer cylindrical portion 192 forms part of the cylindrical clutch housing 116.

A second clutch housing member 115 abuts the outer cylindrical portion 192 of the first clutch housing member 119 and is rigidly coupled thereto by screws 195 to form the clutch housing 116.

Extending into the clutch housing 116 through the second clutch housing member 115 is a connection member 120 which corresponds generally to the connection member 20 of FIG. 1.

The connection member 120 includes a flange portion 122 provided inside the clutch housing. Extending from a radially outer part of the flange portion 122 is an axially short cylindrical portion 123 of the connection member 120, which extends between the inner and outer cylindrical portions 191, 192 of the first clutch housing member 119. The axially short cylindrical portion 123 is supported relative to the inner cylindrical portion 191 by needle bearings 162 and a sleeve 163 provided therebetween.

Provided between the flange portion 122 of the connection member 120 and a radially extending (clutch head) wall of the second clutch housing member 115 is a clutch plate 126, corresponding generally to the clutch plate 26 of FIG. 1. It will be appreciated that the flange portion 122, clutch plate 126 and inner surface of the radially extending wall of the second clutch housing member 115 form a clutch mechanism 117, corresponding generally to the clutch mechanism 17 of FIG. 1. A bush 164 is provided between the second clutch housing member 115 and the connection member 120.

The operating cylinder 128 includes, at its first end, an end housing element in the form of a cylinder head 128a. The remainder of the housing of the operating cylinder 128 is formed by a generally cylindrical main housing element 129. The operating cylinder 128 is provided with an operating piston 132 which has a flange portion 132a and a cylindrical portion 132b and generally corresponds to the piston 32 of FIG. 1. The operating cylinder 128 and operating piston 132 define one (or more depending on the mode of operation) fluid cavity 136. The operating piston 132 may be moved (to the left as shown in FIG. 5) relative to operating the housing 128a, 129 by applying a pressurised fluid (not shown) through a fluid inlet 130. It will be appreciated that as illustrated in FIG. 5, the operating piston 132 abuts the internal second end wall of the operating cylinder, that is, it is at a position corresponding to little or no applied fluid pressure (corresponding to the configuration of FIG. 2). Application of fluid pressure would force the operating piston 132 to the left (as seen in FIG. 5) relative to the operating cylinder 128 to engage the clutch. It will also be noted that no bias member by way of a spring is provided in the operating cylinder 128. This is because in a preferred embodiment (in which the operating fluid is air), the clutch has been formed to disengage effectively when fluid pressure is removed, even without provision of a biasing member. A pneumatic system for adjusting the clutch has been found to give considerable greater accuracy in controlling the clutch than a high pressure hydraulic system, since the fluid pressure can be conveniently regulated within much finer parameters.

A first annular operating cylinder seal 166 is provided in the cylinder head 128a for sealing against the cylindrical portion 132b of the operating piston 132, and a second annular operating cylinder seal 167 is provided in the flange portion 132a of the piston 132 for sealing against the internal wall of the main housing element 129.

Between the operating piston 128 and the sprocket plate 147 are provided a pair of castellated nuts 138. In the embodiment of FIG. 5, the connection member 120 is coupled to the shaft 101 by a grub screw 139 which extends through a threaded bore in the connection member 120. Between the castellated nuts 138 and the operating cylinder 128 is provided a small assembly for handling the thrust which can be applied between these elements when they are rotating relative to each other. The assembly consists of first and second thrust washers 171, 173 with a thrust bearing 172 provided therebetween. A similar assembly is provided between the clutch housing 116 and the operating cylinder 128 (but reference numerals are not provided for this assembly in FIG. 5).

Towards the first end of the shaft 101, an aluminum cover 174 is provided to cover the retaining nut 165. The cover 174 is retained to a first end face of the first end housing element 154 of the worm gear mechanism 112 by a number of fasteners such as cap screws 175 (of which two are shown in FIG. 5). The cover 174 extends for a short axial distance coaxially with the shaft 101, but as, in use, the shaft 101 rotates relative to the cover 174, a sleeve 176 is provided around the shaft 101 in the vicinity of the cover 174 and a roller bearing assembly 177 is provided between the cover 174 and the sleeve 176. An end ring 178 is also provided to act as a seal between the cover 174 and the sleeve 176.

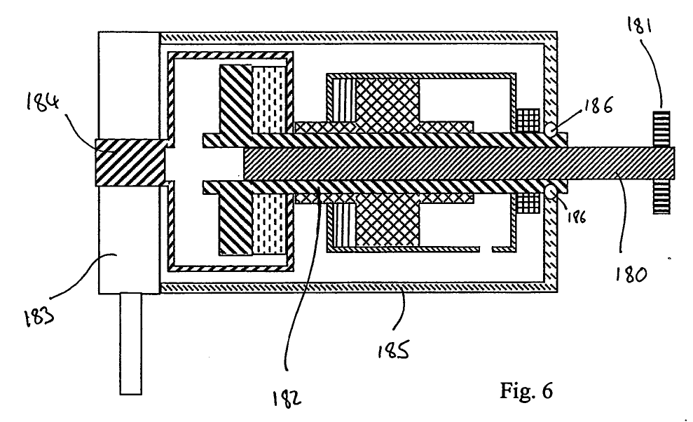

It will be appreciated that in the embodiments described above, a shaft 1, 1a, 1b, 101 passes through the secondary driving element, the clutch mechanism and the operating housing, and the rotational connection or disconnection of the secondary driven element (attached to the driven element by a link in the form of a worm gear) to the coaxial shaft is dictated by operation of the clutch. Although such embodiments are preferred for a number of reasons, including the stabilising effect that a central shaft can provide to the various elements, alternative forms of construction are possible. For example, in the embodiment illustrated in FIG. 6, a shaft 180 on which is mounted a sprocket plate 181 does not extend through the entire mechanism, but extends only into a connection member 182, which corresponds generally to the connection member 20 of FIG. 1. A generally cylindrical member 184, corresponds generally to the generally cylindrical sleeve 14 of FIG. 1, but is illustrated as being solid rather than including a bore for a shaft to pass through. In the absence of a central shaft extending through the mechanism, it is desirable to stabilise the shaft 180 relative to a worm drive 183, and this is achieved by providing a bracket or casing 185 which is securely fixed to the casing of the worm drive 183, and which journals part of the shaft 180, which is spaced apart from the worm drive 183, via a bearing assembly 186.

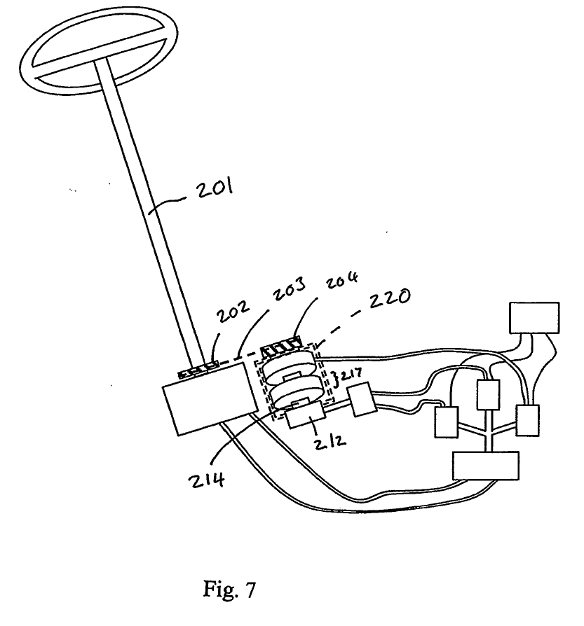

A related but alternative coupling is illustrated schematically in FIG. 7. A steering shaft 201 is driven via a sprocket 202 mounted thereon, which is in turn driven by a chain 203 and a second sprocket 204. Rotational coupling between the second sprocket 204 and a secondary driving element in the form of a cylindrical member 214, driven by a worm gear 212 is provided. A clutch mechanism 217 is provided mechanically between the cylindrical member 214 and the second sprocket 204. Some embodiments might have no shaft coaxial with a secondary driving element such as member 214, and in such circumstances, some other element rotationally coupled to the driven clutch element may be regarded as a driven element. In FIG. 7, the mechanism for rotationally coupling the driven clutch element (not shown) to the second sprocket is not shown, but regardless of the mechanism used, the second sprocket 204 may be regarded as a driven rotational element which rotates coaxially with the link 214 (although it may not be the only driven element which rotates coaxial to the link). As illustrated in FIG. 6, stabilisation of the rotating elements could be provided by suitable external fixings, such as a suitably supported casing or bracket system 220 represented schematically and in broken lines in FIG. 7.

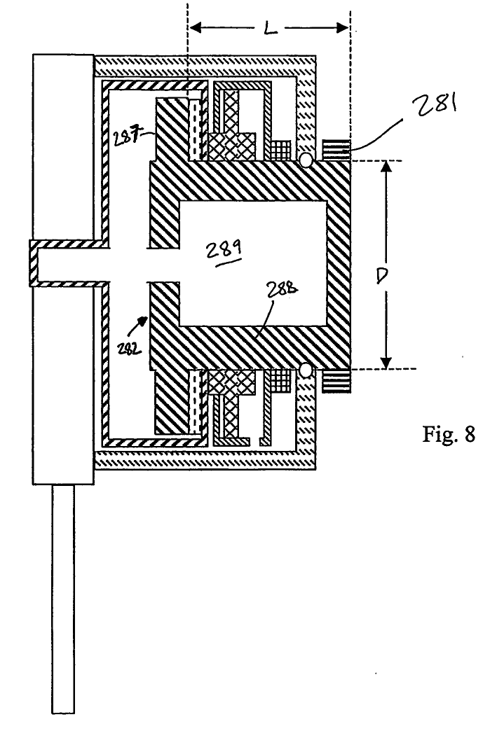

FIG. 8 illustrates an embodiment with many similarities to the embodiment of FIG. 6, but with various elements differently dimensioned. The embodiment of FIG. 8 is, as a whole, relatively axially shorter and radially larger than the embodiment of FIG. 6. The embodiment of FIG. 8 does not include a separate solid elongate driven shaft, but a sprocket 281 is provided on an end portion of a connection member 282. Apart from directly bearing the sprocket 281, the connection member 282 is generally functionally similar to the connection member 182 of FIG. 6, but is proportioned differently. Like the connection member 20 of FIGS. 1 and 2 and the connection members 120, 182 of FIGS. 5 and 6, the connection member 282 has a flange portion 287 and a generally cylindrical shaft portion 288 which may be considered to be a driven element. The sprocket 281 is attached to the end of the shaft portion 288 which is distal from the flange portion 287 and the shaft portion 288 serves to transmit torque, along its axial length between the sprocket 281 and the flange portion 287. As illustrated, the diameter, designated D, of the shaft portion 288 is considerably greater than its axial length, designated L in FIG. 8, but for the purposes of this document, the shaft portion 288 may still be considered a shaft” despite the fact that it might not be considered axially elongate. The connection member 282 is hollow, to reduce weight, and defines a cavity 289 therein. Of course, it is also possible to provide embodiments in which the flange 287, or more probably a corresponding driven element of a clutch assembly, is connected to a driven element other than a shaft. For example, such a driven element could be a sprocket or gear located about the circumference of the clutch element, but the provision of a shaft to transmit rotation from the driven clutch element is preferred.

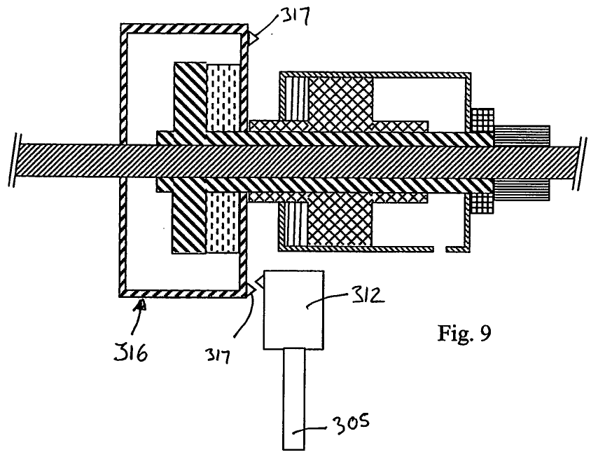

Many variations to the above described embodiments are possible. The above described embodiments include a clutch housing which rotates and a part of the housing which acts as an element of the clutch mechanism, and also include a secondary driving element, such as sleeve 14, for driving the clutch housing. In the above described embodiments, the secondary driving element is located next to the clutch housing along the axis of the coupling, but it will be appreciated that other arrangements are possible. For example, as shown in FIG. 9, a link or gear mechanism 312, connected to a shaft 305 which is an output from an automatically controlled motor, drives a clutch housing 316 via a suitable connection, such as gear teeth 317 on the clutch housing 316. In this case, the clutch housing 316 acts as a secondary driving element between the driving element embodied by the shaft 305 and the clutch mechanism. Of course, in other embodiments, it is not essential that the clutch housing should rotate, or that part of the clutch housing should provide an element of the clutch mechanism, since the clutch could be configured with the clutch mechanism within a stationary housing. Furthermore, in some (although not preferred) embodiments, an output shaft from an automatic control system may be connected directly to a rotatable clutch housing, or to a corresponding element in a clutch mechanism, without a gear arrangement therebetween (for example, by providing a shaft, generally corresponding to the cylindrical sleeve 160 of FIG. 5 as an integral part of the control system output shaft). Typically, in such an embodiment, the output shaft of the automatic control system would be geared, but a suitable choice of motor and/or control system might render such gearing unnecessary.

Of course, it will be appreciated that further modifications and variations of the described embodiments are envisaged which will not be fall outside the scope of the present invention. For example, in a preferred embodiment, sensors are provided to assess the relative movement of the elements of the clutch mechanism and a fluid pressure reduction control system is provided which reacts to a large relative movement (indicating that the automatic steering system is being overridden) by reducing the fluid pressure in the operating cylinder, i.e. allowing the clutch mechanism to disengage. The large relative movement, or difference in rotational speed, may be detected by comparing the rotational velocities of mechanical parts on the mechanically opposite sides of the clutch mechanism. In a preferred embodiment, sensors are provided on the rotatable clutch housing and on the connection member. Active reduction of the fluid pressure facilitates continuous manual override of the automatic steering system. The fluid pressure reduction control system may be incorporated as part of the computerised control system which operates and adjusts the clutch. Alternatively, the fluid pressure reduction control system may be an auxiliary system which reduces the fluid pressure (and sends an appropriate message to the computerised control system) or which instruct the clutch control system to reduce the clutch pressure. Reduction of the fluid pressure is preferably for a relatively short, predetermined length of time or may be terminated by some other parameter such as lack of relative rotational velocity of the driving and driven elements. Cessation of the manual override will therefore result in resumption of the fluid pressure, and resumption of control of the driven element by the automatic steering system.

In a further variation, electromechanical clutch operation is possible: although electromechanical clutches normally operate as on/off systems rather than allowing a substantial degree of slip, a suitable control system for applying an accurately regulated amount of force to a clutch mechanism could be provided in an electromechanical system. The mechanical coupling is not limited in use to coupling a steering shaft to an output of an automatic steering system, but has utility in other areas where it is desired to provide quick and convenient override of a driven rotating element.

Although the shapes of various elements are described, it will be apparent to the skilled person that the shapes and dimensions of many elements may be varied without departing from the scope of the invention, and that relative dimensions (for example, the relationship between axial length and radial dimensions) which may be inferred from use of terms such as “cylindrical” or “shaft” may be varied in various embodiments.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

It is to be understood that, if any prior art publication is referred to herein, such reference does not constitute an admission that the publication forms a part of the common general knowledge in the art, in Australia or in any other country.

Modifications and improvements may be incorporated without departing from the scope of the present invention.

1. A mechanical coupling for coupling a rotatable driving element to a rotatable driven element to be driven by the driving element, wherein the mechanical coupling comprises:
a clutch mechanism, mechanically between the driving element and the driven element; and
wherein the clutch mechanism is adjustable so that in normal use the driving element can drive the driven element substantially without slippage, but so that a given torque applied to said driven element, other than via the clutch, in order to override the action of the driving element, causes the clutch mechanism to slip, thereby overriding said driving element and allowing the driven element to be driven by the overriding torque, substantially without said overriding torque being applied to the driving element.

2. A mechanical coupling as claimed in claim 1, wherein, in use, the clutch is adjustable so that the overriding torque is of a magnitude that can be manually applied to the driven member.

3. A mechanical coupling as claimed in claim 1 wherein, in use, the clutch is adjusted so that the clutch mechanism can slip to prevent transmission of torque greater than a given predetermined torque, from the driving element to the driven element.

4. (canceled)

5. A mechanical coupling as claimed in claim 1, wherein the driven element is an elongate shaft, being greater in axial length than in radial width.

6. A mechanical coupling as claimed in claim 5, wherein the driven element is a steering shaft of a vehicle.

7. A mechanical coupling as claimed in claim 1, wherein the driven element is a member for rotational connection to, and driving of, a shaft.

8. A mechanical coupling as claimed in claim 1, wherein the mechanical coupling includes a secondary driving element which, in use, is provided mechanically between the driving element and the clutch mechanism.

9. A mechanical coupling as claimed in claim 8, wherein, in use, the secondary driving element is rotatable substantially coaxially with the driven element.

10. A mechanical coupling as claimed in claim 8, wherein there is provided a link for connecting the driving element to the secondary driving element.

11. A mechanical coupling as claimed in claim 10, wherein the driving element is connected to the secondary driven element via a gear mechanism.

12. A mechanical coupling as claimed in claim 11, wherein the link includes, constitutes or forms part of the gear mechanism.

13.-15. (canceled)

16. A mechanical coupling as claimed in claim 1, wherein operation and adjustment of the clutch is regulated by an electronic control system.

17. A mechanical coupling as claimed in claim 1 which is provided with a fluid controlled system for adjustment of the clutch.

18. A mechanical coupling as claimed in claim 17, wherein the fluid controlled system includes a fluid chamber configured to fit around a shaft.

19. (canceled)

20. A mechanical coupling as claimed in claim 18, wherein a piston is provided in the fluid chamber and wherein varying the fluid pressure varies a force applied via the piston to rotationally couple first and second clutch elements of the clutch mechanism.

21. A mechanical coupling as claimed in claim 20, wherein the fluid controlled system adjusts the clutch by regulating the fluid pressure which acts upon the piston.

22. A mechanical coupling as claimed in claim 8, wherein the secondary driving element is configured to fit around a shaft.

23.-26. (canceled)

27. A mechanical coupling as claimed in claim 20, wherein application of fluid pressure to the piston forces the piston away from one end of the fluid chamber, and where the increased displacement between the piston and the said one end of the fluid chamber forces clutch elements of the clutch mechanism into, or towards, an engaged configuration.

28. A mechanical coupling as claimed in claim 2, wherein the torque applied to the driven element other than via the clutch mechanism is applied manually via a steering wheel or other steering element.

29. A mechanical coupling as claimed in claim 17, wherein the fluid controlled system is operable from a pump used for the power steering system of the vehicle.

30. A system for coupling an automatic steering control system to a steering system of a vehicle, while allowing manual override of the automatic steering control system by a user operating the normal steering control of the vehicle, said system including a mechanical coupling as claimed in claim 2.

31. A system as claimed in claim 30, wherein the clutch is adjusted by a computerised controller.

32. A system as claimed in claim 31, wherein the computerised controller which adjusts the clutch also operates the automatic steering control system.

33. A method of coupling a rotatable driving element to a rotatable driven element, to be driven by the driving element, comprising the steps of:
providing a clutch mechanism, mechanically between the driving element and the driven element, so that the driven element may be driven by the driving element via the clutch mechanism; and
adjusting the clutch mechanism so that, in normal use, the driving element can drive the driven element substantially without slippage, but so that a given torque applied to said driven element other than via the clutch mechanism, in order to override the action of the driving element, causes the clutch mechanism to slip, thereby overriding said driving element and allowing the driven element to be driven by the overriding torque, without said overriding torque being applied to the driving element.

34. A method as claimed in claim 33, wherein the step of adjusting the clutch mechanism includes adjusting the clutch mechanism so that the torque transmissible by the clutch mechanism without slippage is greater than the torque required to allow the driving element to drive the driven element in normal use, but less than the given overriding torque.

35. A method as claimed in claim 33, wherein the step of adjusting the clutch mechanism includes adjusting the clutch mechanism during rotation of the driving element.

36. A method as claimed in claim 33, wherein the step of adjusting the clutch mechanism includes adjustment so that the overriding torque is of a magnitude that can be manually applied to the driven member.

37. A method as claimed in claim 36, wherein the driving element is an output of an automatic steering system for a vehicle, and the driven element controls the steering of the vehicle.

38. A method as claimed in claim 37, wherein the driven element is one of: a steering shaft of the vehicle; and, an auxiliary element coupled to the steering shaft of the vehicle.

39. A method as claimed in claim 37, wherein the torque applied to the driven element other than via the clutch mechanism is applied manually via a manually operated steering controller.

40. A method as claimed in claim 33, wherein the method includes the step of detecting relative rotation of the driving element and the driven element which corresponds to the driving element being overridden, and least partially releasing the clutch mechanism in response to the detection of the relative rotation.

41. (canceled)
